(19) United States
(12) Patent Application Publication
(10) Pub. No.: US 2025/0220623 A1
(43) Pub. Date: Jul. 3, 2025

(54) SEAMLESS ROAMING IN ULTRA-WIDEBAND

(71) Applicant: Cisco Technology, Inc., San Jose, CA (US)

(72) Inventors: Robert Claudiu Badea, Broadview Heights, OH (US); Sivadeep Reddy Kalavakuru, Akron, OH (US); Raj Kumar Taneja, Twinsburg, OH (US); Ardalan Alizadeh, Milpitas, CA (US)

(73) Assignee: Cisco Technology, Inc., San Jose, CA (US)

(21) Appl. No.: 18/955,158

(22) Filed: Nov. 21, 2024

Related U.S. Application Data
(60) Provisional application No. 63/615,359, filed on Dec. 28, 2023.

(51) Int. Cl. H04W 64/00; H04W 4/02; H04W 76/15

(52) U.S. Cl. CPC H04W 64/00; H04W 4/023; H04W 76/15

(57) ABSTRACT

Seamless roaming and client tracking using Ultra-Wideband (UWB) may be provided. Seamless roaming and client tracking using UWB can comprise receiving a request for a client to subscribe to an UWB seamless roaming and tracking service and receiving a coarse location of the client. A configuration is negotiated for UWB seamless roaming and tracking for the client. A plurality of UWB sessions are created and assigned to a plurality of Access Points (APs) based on the coarse location of the client, wherein the plurality of APs are operable to start the UWB sessions to perform UWB ranging of the client. Ranging reports are received from the plurality of APs, and a location of the client is determined based on the ranging reports.

### RELATED APPLICATION

Under provisions of 35 U.S.C. § 119 (e), Applicant claims the benefit of and priority to U.S. Provisional Application No. 63/615,359, filed Dec. 28, 2023, the disclosure of which is incorporated herein by reference in its entirety.

### TECHNICAL FIELD

The present disclosure relates generally to providing seamless roaming and client tracking using ultra-wideband.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for seamless roaming and tracking using Ultra-Wideband (UWB) in accordance with aspects of the present disclosure.

FIG. 2A and FIG. 2B collectively form FIG. 2, a signal diagram of a signal process for UWB seamless roaming and tracking in accordance with aspects of the present disclosure.

FIG. 3 is a flow chart of a method for seamless roaming and tracking using UWB in accordance with aspects of the present disclosure.

FIG. 4 is a block diagram of a computing device in accordance with aspects of the present disclosure.

FIG. 5 is a block diagram of a communications device in accordance with aspects of the present disclosure.

### DETAILED DESCRIPTION

### Overview

Seamless roaming and client tracking using Ultra-Wideband (UWB) may be provided. Seamless roaming and client tracking using UWB can comprise receiving a request for a client to subscribe to an UWB seamless roaming and tracking service and receiving a coarse location of the client. A configuration is negotiated for UWB seamless roaming and tracking for the client. A plurality of UWB sessions are created and assigned to a plurality of Access Points (APs) based on the coarse location of the client, wherein the plurality of APs are operable to start the UWB sessions to perform UWB ranging of the client. Ranging reports are received from the plurality of APs, and a location of the client is determined based on the ranging reports.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless network standards, such as the Institute of Electrical and Electronics Engineers (IEEE) 802.11be standard, enables wireless Access Points (APs) to utilize onboard Ultra-Wideband (UWB) radios. APs can use UWB radios for enhanced locationing services, such as tracking the location of objects and clients. UWB technology allows for accurate time-of-flight based distance estimation between UWB capable devices. For example, the accuracy of the location estimation using UWB radios can be within a few centimeters in certain environments.

To facilitate communication between a client and a UWB radio onboard an AP, the devices may negotiate a configuration, including credentials for example, prior to enabling the communication link over UWB. The devices may also collect timestamp data to estimate the distance between the devices. The initial communications prior to enabling the link over UWB may be Out-of-Band (OOB) communication and can be performed via different communication methods such as short-range wireless methods, Wi-Fi, distributed computing (e.g., cloud) enabled applications, and/or the like. Currently, as a client moves throughout the network and moves out of range of an AP (e.g., reduced link budget, reduced Received Signal Strength Indicator (RSSI)) the client is currently communicating with, the client must then re-negotiate credentials and configurations with a new AP to enable communication with the new AP. This re-negotiation process can lead to down-time and increased overhead on both ends of the link.

APs can utilize UWBs to provide seamless roaming for clients, providing the clients a constant connection during movement within the network's coverage area. To provide seamless roaming, the APs may physically track clients and other assets in real time. Enabling seamless roaming can eliminate the down-time and increased overhead by removing the need to perform re-negotiation when a client roams. Seamless roaming can reduce latency, reduce service interference, improve reliability, reduce overhead, and enhance security of the network.

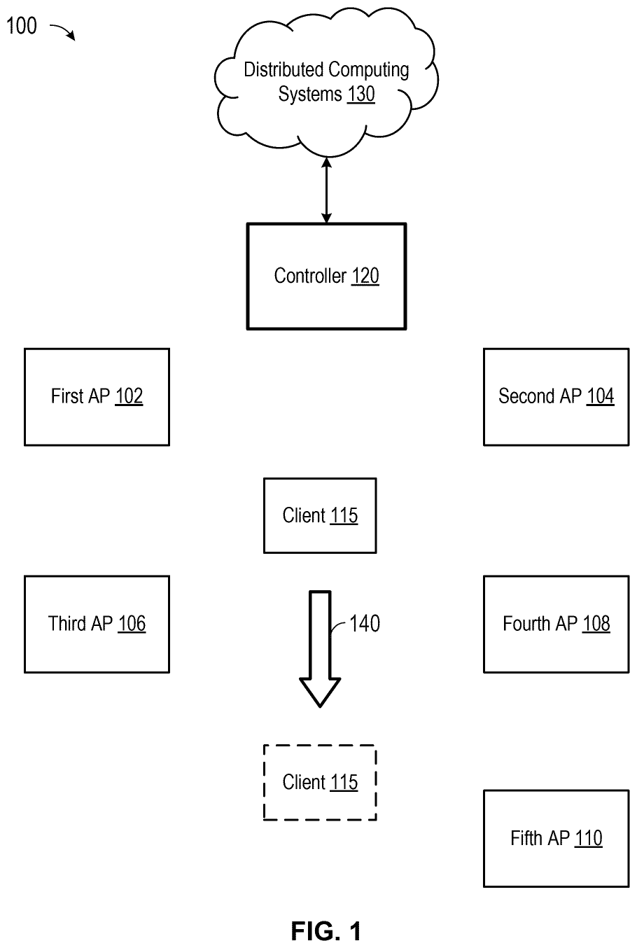

FIG. 1 is a block diagram of an operating environment 100 for seamless roaming and tracking using UWB. The operating environment 100 can include a first AP 102, a second AP 104, a third AP 106, a fourth AP 108, a fifth AP 110, a client 115, a controller 120, and distributed computing systems 130. The first AP 102, the second AP 104, the third AP 106, the fourth AP 108, and the fifth AP 110 may enable devices to access the wireless network and provide services such as location tracking and enabling seamless roaming between the APs. The client 115 may be a device that accesses the network, such as a personal computer, a server, a tablet, a laptop, a smart phone, or the like.

The controller 120 can be any controller, such as a Wireless Local Area Network Controller (WLC), that manages the devices of the network. The controller 120 can manage the operation of the first AP 102, the second AP 104, the third AP 106, the fourth AP 108, and the fifth AP 110 and enable services such as location tracking and seamless roaming. The distributed computing systems 130 may be physically remote systems for information processing and distribution, such as devices accessed via the Internet. However, the distributed computing systems 130 may be local in certain embodiments. The distributed computing systems 130 can host various applications such as location services, cloud computing services, cloud controller routing, security services, and/or the like. For example, the distributed computing systems 130 can determine AP assignments for UWB tracking, provide information to the client 115 and other devices, and so on.

The network devices, such as the first AP 102, the second AP 104, the third AP 106, the fourth AP 108, and the fifth AP 110 can advertise the availability of UWB seamless roaming and tracking, for example using OOB communication. When the client 115 determines the UWB seamless roaming service is available via the advertisement, the client 115 can subscribe to the service. To subscribe to or otherwise enable UWB seamless roaming, the client 115 and one or more network devices can perform an initial configuration negotiation to determine the configuration, negotiate credentials, and the like. The negotiation can include acknowledging that the network devices, such as the APs and the controller 120, will track the client 115. The negotiation can also include determining the tracking format or technique the network devices will use for ranging (e.g., double-sided two-way ranging), determining the layer configuration (e.g., Physical (PHY) layer configuration, Media Access Control (MAC) layer configuration), exchanging a session ID, exchanging device addresses, setting device types, assigning device roles, determining a multi-node mode (e.g., one-to-one, one-to-many), encryption configuration (e.g., determining security keys for Station-to-Station (STS) encryption), and/or the like. In example implementations, the client 115 takes the role of controller, initiating communication to the APs and establishing a schedule for every block of communication. The APs take the role of controlees in this example implementation. In some embodiments, the device role of the client 115 is set to an initiator and the device roles of the APs are set to responders.

One or more of the network devices, such as one or more APs and/or the controller 120, may identify a coarse location of the client 115 during the initial negotiation or to trigger the initial negotiation. The network device(s) can receive the coarse location of the client 115 via the client 115 allowing the network devices to access to location information on the device such as Global Positioning System (GPS) data, RSSI information for OOB discovery, and/or the like. The network device(s) and the client 115 can perform the initial negotiation once the network device(s) determine the course location of the client 115, for example including agreeing on a common UWB application configuration determining credentials, and so on. The network device(s) can create a set of UWB sessions and share the UWB session information (Session ID, UWB Addresses, STS Keys, etc.) with the client 115 for configuring the UWB radio(s) of the client 115.

The controller 120 can assign or otherwise determine the initial set APs to communicate with the asset over UWB based on the coarse location of the client 115 and/or initial signal strengths (e.g., RSSI). In some embodiments, the distributed computing systems 130 can provide applications for determining the initial set of APs, such as cloud-controlled Wi-Fi, routing, and location services. The controller 120 can provide the coarse location of the client 115 and/or initial signal strengths to the distributed computing systems 130 for the determination of the APs.

To accurately determine the location of the client 115, at least three APs may perform ranging to triangulate the location of the client 115. The ranging technique comprises time of flight localization between the client 115 and each respective AP in example implementations. In certain embodiments, four or five APs create unique UWB sessions with the client 115. Each AP that creates a unique UWB session with the client 115 may determine or otherwise be assigned a unique UWB short address. Each UWB short address is two bytes in example embodiments. When a multi-node session is utilized, a single UWB session can be created with the client 115, and unique UWB short addresses can be assigned or otherwise determined for each AP performing ranging.

Once the UWB sessions have been established with the initial set of APs, the assigned APs and other network device begin ranging by initializing, configuring, and starting the corresponding sessions. For example, the initial set of APs includes the first AP 102, the second AP 104, the third AP 106, and the fourth AP 108. The first AP 102, the second AP 104, the third AP 106, and the fourth AP 108 will each initiate a UWB session with the client 115 and begin ranging.

The client 115 will range with each AP that imitated a UWB. The client 115 will provide to the APs client-to-AP distance information for determining the location of the client 115. The APs will periodically send ranging reports to the controller 120 and/or the distributed computing systems 130. The ranging reports can include the client-to-AP distance information, diagnostic information such as RSSI and measurement error rates, and/or the like. The controller 120 and/or the distributed computing systems 130 use the ranging reports to calculate the precise location of the client 115 within the network in real-time, for example using multilateration. The controller 120 and/or the distributed computing systems 130 can then be share the determined location with the client 115. In some embodiments, the distributed computing systems 130 shares the determined location via an application, such as a location service hosted by the distributed computing systems 130.

If the client moves out of range or otherwise has an insufficient link budget with any of the APs performing ranging, the network devices may not be able to accurately determine the location of the client 115. Enabling seamless roaming facilitates the continuous tracking of the client 115 as long as the client 115 is in the service area of the network because when the client 115 moves out of range of an AP, the client 115 can begin communicating with a different AP that the client 115 moves within range of or is otherwise already in range of. For example, the client 115 may move out of range of the first AP 102 and move within range of the fifth AP 110. The client 115 may seamlessly roam to the fifth AP 110 so the second AP 104, the third AP 106, the fourth AP 108, and the fifth AP 110 can perform ranging and continue tracking the client 115.

As the client 115 begins to move out of range of one or more of the APs, the ranging reports the APs send to the controller 120 and/or the distributed computing systems 130 will indicate the client 115 cannot continue to communicate with the AP the client 115 is moving out of range. For example, the ranging reports may indicate a failing link budget for an AP via health diagnostic metrics. The controller 120 and/or the distributed computing systems 130 can then reassign the session attached to the AP the client 115 is moving out of range of (e.g., as indicated by the degrading link budget) to a new candidate AP with higher potential for continual link budget to the client 115. Reassigning the session can include assigning the UWB short address to the new AP.

The controller 120 and/or the distributed computing systems 130 can select the new AP for the client 115 to roam to based on the recent location estimates of the client 115. For example, the controller 120 and/or the distributed computing systems 130 can generate a velocity vector of the estimated path of the client 115 to project the movement of the client 115 and select the new AP to best intercept that trajectory or otherwise provide coverage at the expected location of the client 115 based on the velocity vector. In an example, the controller 120 and/or the distributed computing systems 130 determine that the client 115 is moving away from the first AP 102 or otherwise has a low link budget with the first AP 102 and that the client 115 is moving toward the fifth AP 110. Thus, the controller 120 and/or the distributed computing systems 130 may reassign the UWB session of the first AP 102 to the fifth AP 110. The controller 120 and/or the distributed computing systems 130 can generate a velocity vector 140 to estimate the movement of the client 115 when determining to reassign the UWB session of the first AP 102 to the fifth AP 110.

If new AP fails to establish communication with the client 115, such as if the client 115 doesn't actually travel within range of the new AP, the controller 120 and/or the distributed computing systems 130 can continue reassigning the session in the neighboring area to APs until communication on that session credential is re-established. For example, the controller 120 and/or the distributed computing systems 130 can recompute the velocity vector to determine a more accurate estimated path to select another AP to be reassigned the UWB session for the client 115.

Because the APs act as responders for the UWB ranging, the client 115 may not be notified of the reassignment of the UWB session credentials to a new AP, and the client 115 can continue ranging according to the new UWB ranging blocks with control messages, instructing the updated set of APs to send ranging messages. The new AP will then respond with an UWB ranging message. The network may manage the assignment and reassignment of APs, so the client 115 does not need to be notified when UWB sessions are reassigned to new APs.

Multiple clients can be tracked simultaneously by time-slicing the responder sessions among the unique clients assigned to an AP at any given moment. Thus, the operating environment 100 can include multiple clients 115 in some embodiments. The clients, including the client 115 for example, may be instructed to attempt to range as often as possible (e.g., every twelve milliseconds when deferred Double-Sided Two-Way-Ranging is used). The network devices will respond when the respective client is scheduled to be allotted time for ranging, collecting adequate distance metrics and sharing ranging reports with the controller 120 and/or distributed computing systems 130.

The operating environment 100 can include a different number of devices in further embodiments. For example, there can be a different number of APs providing coverage in the service area of the network, more controllers, more clients, different devices for providing location services, and/or the like. As described above, the APs, the controller 120, the distributed computing systems 130, and/or other network devices can enable UWB tracking and seamless roaming for one or more clients 115 in the operating environment 100.

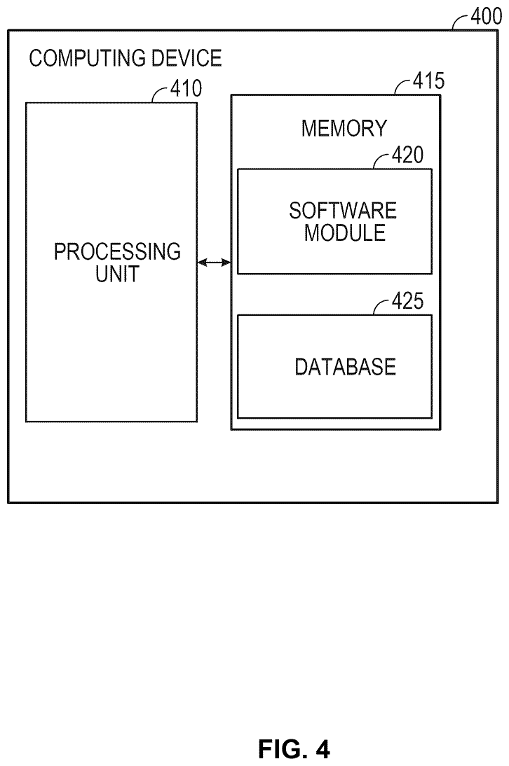

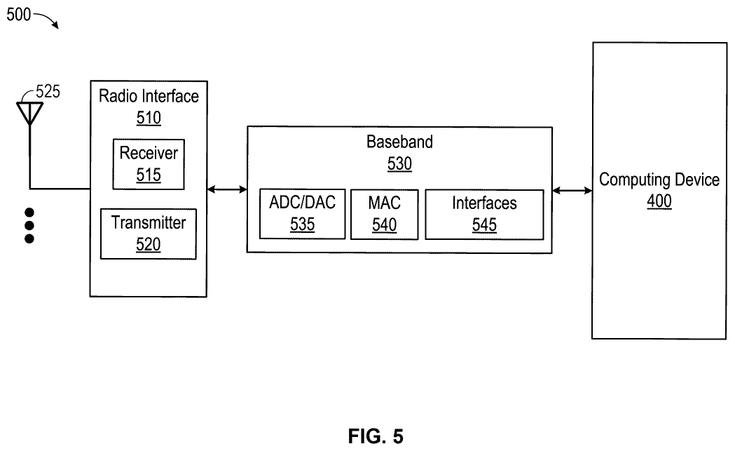

The elements described above of the operating environment 100 (e.g., the first AP 102, the second AP 104, the third AP 106, the fourth AP 108, the fifth AP 110, the client 115, the controller 120, the distributed computing systems 130, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 4 and 5, the elements of the operating environment 100 may be practiced in a computing device 400 and/or communications device 500.

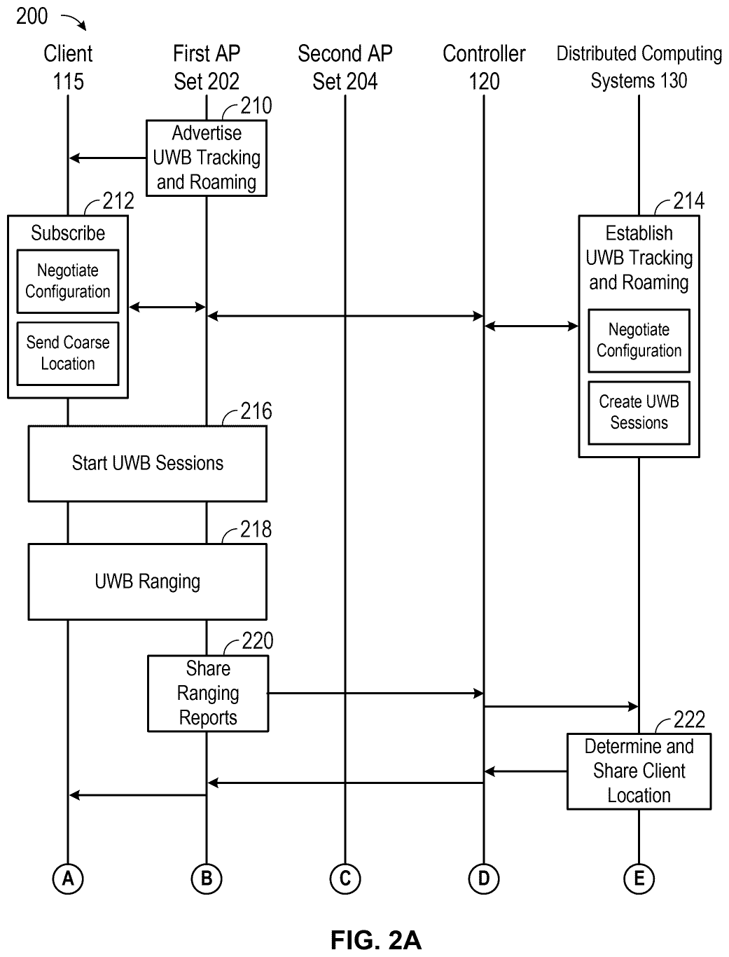

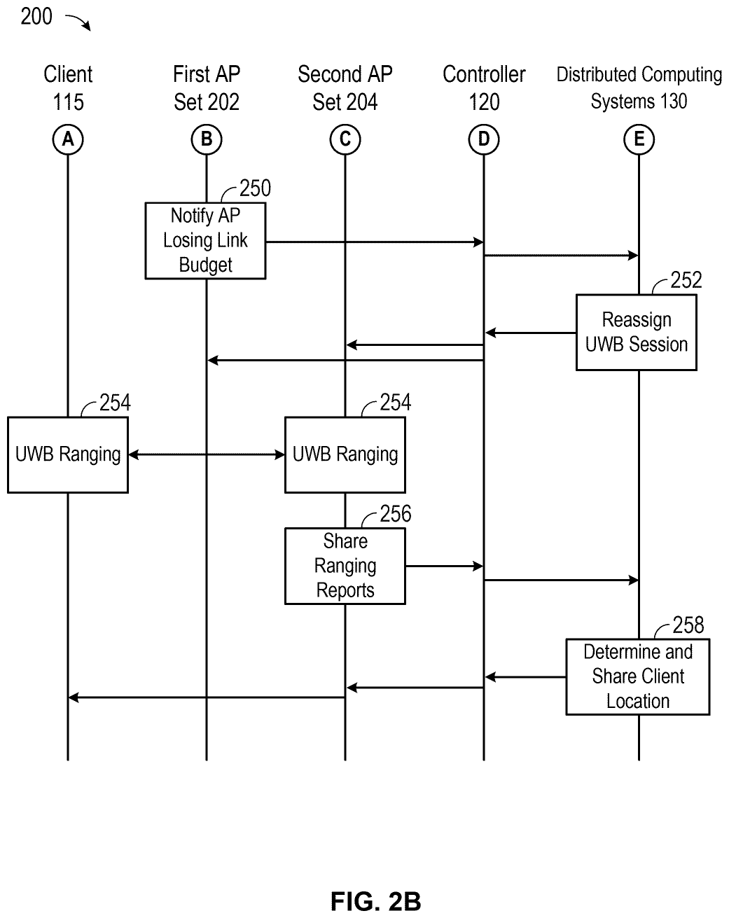

FIG. 2A and FIG. 2B collectively form FIG. 2, a signal diagram of a signal process 200 for UWB seamless roaming and tracking. As shown in FIG. 2A, the signal process 200 may be between the client 115, a first AP set 202, a second AP set 204, the controller 120, and the distributed computing systems 130. The first AP set 202 may include the first AP 102, the second AP 104, the third AP 106, and the fourth AP 108. The controller 120 and/or the distributed computing systems 130 can determine the APs included in the first AP set 202 when establishing the UWB tracking and seamless roaming capabilities with the client. Therefore, the first AP set 202 may be determined during the signal process 200. The second AP set 204 may include the second AP 104, the third AP 106, the fourth AP 108, and the fifth AP 110. The controller 120 and/or the distributed computing systems 130 can determine the APs included in the second AP set 204 when determining to reassign a UWB session, such as to reassign the UWB session from the first AP 102 to the fifth AP 110. The first AP set 202 and the second AP set 204 are shown as two separate groups in the illustrated embodiment for clarity, and the AP with an insufficient link budget with the client 115 may simply be replaced with a new AP by reassigning the UWB session.

In the illustrated embodiment, the APs communicate with the controller 120, and the controller 120 communicates with the distributed computing systems 130. The APs can communicate directly with the distributed computing systems 130 in additional embodiments. Additionally, the controller 120 may perform the operations of the distributed computing systems 130, such as establishing UWB tracking and seamless roaming, determining the location of the client 115, reassigning UWB sessions, and/or the like. The APs are also shown to communicate with the client 115; however, the controller 120 and/or the distributed computing systems 130 may communicate directly with the client 115 in example implementations. Thus, the operations of the controller 120 and the distributed computing systems 130 can be interchangeable and the devices may communicate in other ways than shown in the signal process 200. In some embodiments, one or more of the APs may perform one or more of the operations of the controller 120 and/or the distributed computing systems 130.

As shown in FIG. 2A, the signal process 200 can begin with operation 210. In operation 210, the UWB tracking and roaming capability is advertised, such as via OOB communication. The APs of the first AP set 202 may be within range of the client 115 and may advertise the UWB tracking and roaming capability. In response to the advertisement, the client 115 can subscribe to the UWB tracking and roaming capability in operation 212. As described above, subscribing to the UWB tracking and roaming capability can include negotiating the UWB configuration and sharing the coarse location of the client 115. In operation 214, the distributed computing systems 130 can establish the UWB tracking and roaming capability by performing the negotiation of the configuration with the client 115 and creating UWB sessions. The distributed computing systems 130 can determine the APs included in the first AP set 202 based on the coarse location of the client 115 and assign UWB sessions to the first AP set 202.

In operation 216, the first AP set 202 and the client 115 can initiate UWB ranging by initializing, configuring, and starting the UWB sessions created in operation 214. The first AP set 202 and the client 115 can then perform UWB ranging in operation 218. UWB ranging may include the client 115 requesting each AP in the first AP set 202 to perform ranging, for example according to the negotiated UWB configuration. The first AP set 202 can then send ranging reports to the controller 120 and/or the distributed computing systems 130 in operation 220. In example implementations, the ranging reports comprise the client-to-AP distance information, diagnostic information such as RSSI and measurement error rates, and/or the like. Using the ranging reports, the distributed computing systems 130 determines the location of the client 115 and shares the location with the client 115 in operation 222.

The client 115, the first AP set 202, the controller 120, and/or the distributed computing systems 130 can repeat operation 218, operation 220, and operation 222 as desired to maintain an accurate location estimation of the client 115. For example, operation 218, operation 220, and operation 222 may be repeated according to the schedule established for every block of communication when the UWB configuration is negotiated.

The signal process 200 continues in FIG. 2B. The client 115 may have moved and has an insufficient link budget with an AP of the first AP set 202, such as the first AP 102. In operation 250, the first AP set 202 notifies the controller 120 and/or the distributed computing systems 130 that an AP has an insufficient link budget with the client 115. The notification may be a ranging report, such as the ranging reports sent in operation 220 in some embodiments, and the distributed computing systems 130 can determine there is insufficient link budget for an AP using the ranging reports. In operation 252, the distributed computing systems 130 can reassign the UWB session for the AP with insufficient link budget with a new AP, thereby creating the second AP set 204. The distributed computing systems 130 can reassign the UWB session to the new AP based on the location of the client 115, a velocity vector (e.g., the velocity vector 140), RSSI of neighbor APs, and/or the like.

Once the UWB session is reassigned, the second AP set 204 and the client 115 can perform UWB ranging in operation 254. The second AP set 204 can then send ranging reports to the controller 120 and/or the distributed computing systems 130 in operation 256. In example implementations, the ranging reports comprise the client-to-AP distance information, diagnostic information such as RSSI and measurement error rates, and/or the like. Using the ranging reports, the distributed computing systems 130 determines the location of the client 115 and shares the location with the client 115 in operation 258.

The client 115, the second AP set 204, the controller 120, and/or the distributed computing systems 130 can repeat operation 254, operation 256, and operation 258 as desired to maintain an accurate location estimation of the client 115. For example, operation 254, operation 256, and operation 258 may be repeated according to the schedule established for every block of communication when the UWB configuration is negotiated.

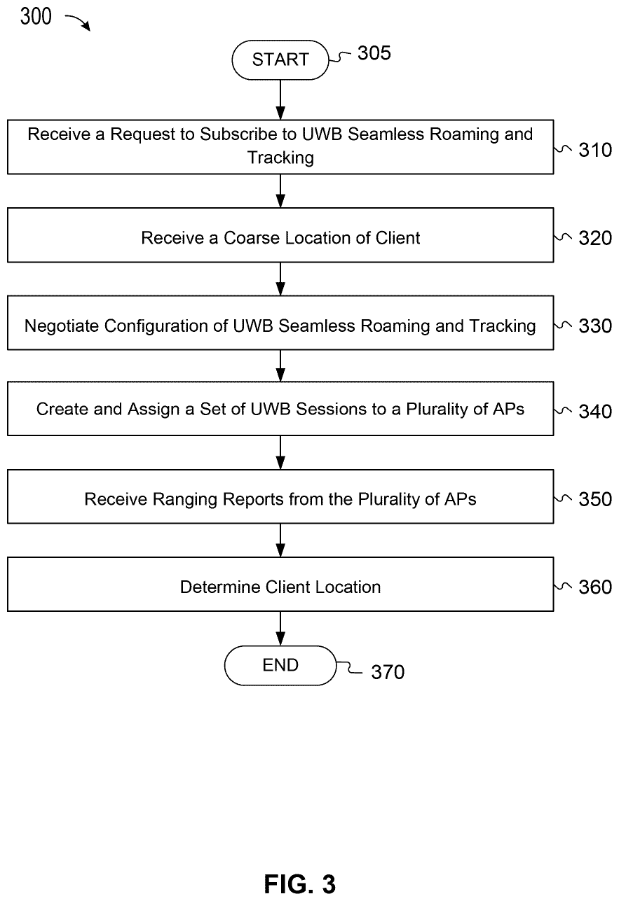

FIG. 3 is a flow chart of a method 300 for seamless roaming and tracking using UWB. The method 300 may begin at starting block 305 and proceed to operation 310. In operation 310, a request is received for a client to subscribe to an UWB seamless roaming and tracking service. For example, the client 115 receives an advertisement of the UWB seamless roaming and tracking service and requests to subscribed to the service. The controller 120 and/or the distributed computing systems 130 can receive the request and initiate establishing the UWB tracking and seamless roaming service for the client 115. In operation 320, a coarse location of the client is received. The client 115 may send a coarse location when requesting to subscribe to the UWB seamless roaming and tracking service or when negotiating the UWB configuration.

In operation 330, a configuration is negotiated for UWB seamless roaming and tracking for the client. For example the client 115, the controller 120, and/or the distributed computing systems 130 negotiate the configuration for UWB seamless roaming and tracking for the client 115. The negotiation can include acknowledging that the network devices will track the client 115, determining the tracking format or technique the network devices will use for ranging, determining the layer configuration, exchanging a session ID, exchanging device addresses, setting device types, assigning device roles, determining a multi-node mode, determining the encryption configuration, and/or the like.

In operation 340, a plurality of UWB sessions are created and assigned to a plurality of APs based on the coarse location of the client wherein the plurality of APs are operable to start the plurality of UWB sessions to perform UWB ranging of the client. For example, the controller 120 and/or the distributed computing systems 130 create UWB sessions for the first AP set 202. The UWB sessions can include a session identifier, a UWB address, a security key, and/or the like. The UWB sessions can include schedules for ranging (e.g., for every block of communication). In some embodiments, the controller 120 and/or the distributed computing systems 130 can share UWB session information with the client 115, such as the session identifier, the UWB address, the security key, and/or the like. In some embodiments, the UWB addresses are UWB short addresses assigned to the APs. The APs assigned UWB sessions can then perform UWB ranging with the client 115.

In operation 350, ranging reports are received from the plurality of APs. For example, the controller 120 and/or the distributed computing systems 130 receive ranging reports from the first AP set 202. The ranging reports can include client-to-AP distance information, diagnostic information such as RSSI and measurement error rates, and/or the like.

In operation 360, a location of the client is determined based on the ranging reports. For example, the controller 120 and/or the distributed computing systems 130 use the ranging reports to calculate the precise location of the client 115 within the network in real-time. The first AP set 202 and the client 115 can continue ranging, the first AP set 202 can continue sending ranging reports, and the controller 120 and/or the distributed computing systems 130 can use the new ranging reports to update the real-time location of the client 115.

In some embodiments, a new ranging report is received indicating an AP of the plurality of APs has an insufficient link budget with the client, and a UWB session of the AP is reassigned to a new AP. For example, the controller 120 and/or the distributed computing systems 130 use the ranging reports to determine the first AP 102 has an insufficient link budget with the client 115 and reassign the UWB session of the first AP 102 to the fifth AP 110. Thus, the second AP set 204 can now perform UWB ranging with the client 115. In certain embodiments, an estimated path of the client is determined, and the new AP is selected based on the estimated path. For example, the controller 120 and/or the distributed computing systems 130 determine the estimated path of the client 115 and select the fifth AP 110 based on the estimated path. The estimated path may be the velocity vector 140 in example implementations. In some embodiments, it is determined that the new AP fails to establish communication with the client, and the UWB session of the AP is reassigned to a second new AP. For example, the client 115 may not move within range of the fifth AP 110, so the controller 120 and/or the distributed computing systems 130 select a second new AP to reassign the UWB session of the first AP 102 and may continue attempting to reassign the UWB session until the reassignment is successful.

In some embodiments, the plurality of UWB sessions may be time-sliced with a second plurality of UWB sessions of a second client. For example, the controller 120 and/or the distributed computing systems 130 may time-slice the UWB sessions of the client 115 with UWB sessions of one or more other clients. The APs can therefore perform ranging for multiple clients without interference. The method 300 may conclude at ending block 370.

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for UWB seamless roaming and tracking with respect to FIG. 1, FIG. 2, and FIG. 4. Computing device 400, for example, may provide an operating environment for first AP 102, the second AP 104, the third AP 106, the fourth AP 108, the fifth AP 110, the client 115, the controller 120, the distributed computing systems 130, and the like. The first AP 102, the second AP 104, the third AP 106, the fourth AP 108, the fifth AP 110, the client 115, the controller 120, the distributed computing systems 130, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

FIG. 5 illustrates an implementation of a communications device 500 that may implement one or more of the first AP 102, the second AP 104, the third AP 106, the fourth AP 108, the fifth AP 110, the client 115, the controller 120, the distributed computing systems 130, etc., of FIGS. 1-3. In various implementations, the communications device 500 may comprise a logic circuit. The logic circuit may include physical circuits to perform operations described for one or more of the first AP 102, the second AP 104, the third AP 106, the fourth AP 108, the fifth AP 110, the client 115, the controller 120, the distributed computing systems 130, etc., of FIGS. 1-3, for example. As shown in FIG. 5, the communications device 500 may include one or more of, but is not limited to, a radio interface 510, baseband circuitry 530, and/or the computing device 400.

The communications device 500 may implement some or all of the structures and/or operations for the first AP 102, the second AP 104, the third AP 106, the fourth AP 108, the fifth AP 110, the client 115, the controller 120, the distributed computing systems 130, etc., of FIGS. 1-3, storage medium, and logic circuit in a single computing entity, such as entirely within a single device. Alternatively, the communications device 500 may distribute portions of the structure and/or operations using a distributed system architecture, such as a client station server architecture, a peer-to-peer architecture, a master-slave architecture, etc.

A radio interface 510, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 510 may include, for example, a receiver 515 and/or a transmitter 520. The radio interface 510 may include bias controls, a crystal oscillator, and/or one or more antennas 525. In additional or alternative configurations, the radio interface 510 may use oscillators and/or one or more filters, as desired.

The baseband circuitry 530 may communicate with the radio interface 510 to process, receive, and/or transmit signals and may include, for example, an Analog-To-Digital Converter (ADC) for down converting received signals with a Digital-To-Analog Converter (DAC) 535 for up converting signals for transmission. Further, the baseband circuitry 530 may include a baseband or PHY layer processing circuit for the PHY link layer processing of respective receive/transmit signals. Baseband circuitry 530 may include, for example, a MAC processing circuit 540 for MAC/data link layer processing. Baseband circuitry 530 may include a memory controller for communicating with MAC processing circuit 540 and/or a computing device 400, for example, via one or more interfaces 545.

In some configurations, PHY processing circuit may include a frame construction and/or detection module, in combination with additional circuitry such as a buffer memory, to construct and/or deconstruct communication frames. Alternatively or in addition, MAC processing circuit 540 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving a request for a client to subscribe to an Ultra-Wideband (UWB) seamless roaming and tracking service;
receiving a coarse location of the client;
negotiating a configuration for UWB seamless roaming and tracking for the client;
creating and assigning a plurality of UWB sessions to a plurality of Access Points (APs) based on the coarse location of the client, wherein the plurality of APs are operable to start the plurality of UWB sessions to perform UWB ranging of the client;
receiving ranging reports from the plurality of APs; and
determining a location of the client based on the ranging reports.

2. The method of claim 1, further comprising sending UWB session information to the client, wherein the UWB session information comprises, for each UWB session of the plurality of UWB sessions, any one of (i) a session identifier, (ii) a UWB address, (iii) a security key, or (iv) any combination of (i)-(iii).

3. The method of claim 1, further comprising assigning each AP of the plurality of APs a UWB short address.

4. The method of claim 1, further comprising:
receiving a new ranging report indicating an AP of the plurality of APs has an insufficient link budget with the client; and
reassigning a UWB session of the AP to a new AP, wherein the new AP and APs and APs still assigned UWB sessions of the plurality of APs are operable to perform UWB ranging of the client.

5. The method of claim 4, further comprising:
determining an estimated path of the client; and
selecting the new AP based on the estimated path.

6. The method of claim 4, further comprising:
determining the new AP fails to establish communication with the client; and
reassigning the UWB session of the AP to a second new AP.

7. The method of claim 1, further comprising time-slicing the plurality of UWB sessions with a second plurality of UWB sessions of a second client.

8. A system comprising:
a memory storage; and
a processing unit coupled to the memory storage, wherein the processing unit is operative to:
receive a request for a client to subscribe to an Ultra-Wideband (UWB) seamless roaming and tracking service;
receive a coarse location of the client;
negotiate a configuration for UWB seamless roaming and tracking for the client;
create and assign a plurality of UWB sessions to a plurality of Access Points (APs) based on the coarse location of the client, wherein the plurality of APs are operable to start the plurality of UWB sessions to perform UWB ranging of the client;
receive ranging reports from the plurality of APs; and
determine a location of the client based on the ranging reports.

9. The system of claim 8, the processing unit being further operative to sending UWB session information to the client, wherein the UWB session information comprises, for each UWB session of the plurality of UWB sessions, any one of (i) a session identifier, (ii) a UWB address, (iii) a security key, or (iv) any combination of (i)-(iii).

10. The system of claim 8, the processing unit being further operative to assign each AP of the plurality of APs a UWB short address.

11. The system of claim 8, the processing unit being further operative to:
receive a new ranging report indicating an AP of the plurality of APs has an insufficient link budget with the client; and
reassign a UWB session of the AP to a new AP, wherein the new AP and APs still assigned UWB sessions of the plurality of APs are operable to perform UWB ranging of the client.

12. The system of claim 11, the processing unit being further operative to:
determine an estimated path of the client; and
select the new AP based on the estimated path.

13. The system of claim 11, the processing unit being further operative to:
determine the new AP fails to establish communication with the client; and
reassign the UWB session of the AP to a second new AP.

14. The system of claim 8, the processing unit being further operative to time-slice the plurality of UWB sessions with a second plurality of UWB sessions of a second client.

15. A non-transitory computer-readable medium that stores a set of instructions which when executed perform a method executed by the set of instructions comprising:
receiving a request for a client to subscribe to an Ultra-Wideband (UWB) seamless roaming and tracking service;
receiving a coarse location of the client;
negotiating a configuration for UWB seamless roaming and tracking for the client;
creating and assigning a plurality of UWB sessions to a plurality of Access Points (APs) based on the coarse location of the client, wherein the plurality of APs are operable to start the plurality of UWB sessions to perform UWB ranging of the client;
receiving ranging reports from the plurality of APs; and
determining a location of the client based on the ranging reports.

16. The non-transitory computer-readable medium of claim 15, the method executed by the set of instructions further comprising sending UWB session information to the client, wherein the UWB session information comprises, for each UWB session of the plurality of UWB sessions, any one of (i) a session identifier, (ii) a UWB address, (iii) a security key, or (iv) any combination of (i)-(iii).

17. The non-transitory computer-readable medium of claim 15, the method executed by the set of instructions further comprising assigning each AP of the plurality of APs a UWB short address.

18. The non-transitory computer-readable medium of claim 15, the method executed by the set of instructions further comprising:
receiving a new ranging report indicating an AP of the plurality of APs has an insufficient link budget with the client; and
reassigning a UWB session of the AP to a new AP, wherein the new AP and APs still assigned UWB sessions of the plurality of APs are operable to perform UWB ranging of the client.

19. The non-transitory computer-readable medium of claim 18, the method executed by the set of instructions further comprising:
determining an estimated path of the client; and
selecting the new AP based on the estimated path.

20. The non-transitory computer-readable medium of claim 18, the method executed by the set of instructions further comprising:
determining the new AP fails to establish communication with the client; and
reassigning the UWB session of the AP to a second new AP.
